(19) United States
(12) Patent Application Publication
(10) Pub. No.: US 2015/0198850 A1
(43) Pub. Date: Jul. 16, 2015

(54) LIQUID CRYSTAL DISPLAY DEVICE

(71) Applicant: Sharp Kabushiki Kaisha, Osaka (JP)

(72) Inventors: Yasutoshi Tasaka, Osaka (JP); Noboru Nakanishi, Osaka (JP); Yasuyoshi Kaise, Osaka (JP)

(73) Assignee: Sharp Kabushiki Kaisha, Osaka (JP)

(21) Appl. No.: 14/415,429

(22) PCT Filed: Jul. 16, 2013
(86) PCT No.: PCT/JP2013/069237

§ 371 Date: Jan. 16, 2015

(30) Foreign Application Priority Data
Jul. 19, 2012 (JP) 2012-160848

(51) Int. Cl. G02F 1/1362; G02F 1/133; G02F 1/1368

(52) U.S. Cl. CPC G02F 1/136286; G02F 1/1368; G02F 1/13306; G02F 1/136277

(57) ABSTRACT

In a liquid crystal display device, a plurality of pixel electrodes respectively connected to a plurality of source bus lines are arranged along an extension direction of the source bus line, the pixel electrodes being alternately displaced to one side and then the other in an arrangement direction of the plurality of source bus lines. Thin film transistors each include a semiconductor layer containing a source portion, a channel portion and a drain portion, and a gate electrode formed using a portion of the gate bus line. The source portion, the channel portion and the drain portion are arranged so as to be adjacent to one another in a direction perpendicular to the arrangement direction of the plurality of source bus lines. The gate electrode extends in a direction parallel to the arrangement direction of the plurality of source bus lines and is arranged to oppose the channel portion.

### TECHNICAL FIELD

The present invention relates to a liquid crystal display device.

This application claims priority based on Japanese Patent Application No. 2012-160848 filed in Japan on Jul. 19, 2012, the contents of which are incorporated herein.

### BACKGROUND ART

One well-known embodiment of a liquid crystal display device uses an inversion driving method. Various inversion driving methods have been proposed, including a frame inversion method, a line inversion method, a column inversion method, and a dot inversion method.

For example, Patent Document 1 discloses a liquid crystal display device that uses a so-called Z-inversion method whereby data lines are driven using the column inversion method and liquid crystal cells are driven using the dot inversion method.

### RELATED ART DOCUMENT

### Patent Document

Patent Document 1: Japanese Patent Application Laid-Open Publication No. 2007-249240

### SUMMARY OF THE INVENTION

### Problems to be Solved by the Invention

However, when the liquid crystal display device is manufactured, a shift can occur in the positioning of wiring layers such as the data line or gate line layers relative to the thin-film transistors, causing a misalignment. The liquid crystal display device of Patent Document 1 was not configured to take the misalignment into account. As a result, there was a problem in that when a misalignment occurred, the thin-film transistor holding characteristics changed, causing a deterioration in display quality.

The present invention was conceived to solve the above-described problem, and aims to provide a liquid crystal display device capable of suppressing variation in the holding characteristics of the thin-film transistors and thus suppress the deterioration in display quality.

### Means for Solving the Problem

In order to achieve the above-described aim, the present invention provides the following.

(1) Specifically, the liquid crystal display device according to a first aspect of the present invention includes: a plurality of source bus lines arranged to be adjacent to one another; a plurality of gate bus lines arranged to be adjacent to each other and to intersect with the plurality of source bus lines; a plurality of thin film transistors respectively provided at intersections of the plurality of source bus lines and the plurality of gate bus lines; a plurality of pixel electrodes provided in one-to-one correspondence with the plurality of thin film transistors, image signals being supplied to the plurality of pixel electrodes from the source bus lines via the thin film transistors; and a source driver that respectively supplies the image signals to the plurality of source bus lines, the image signals reversing a polarity between positive potential and negative potential upon every period, wherein, for each source bus line, the plurality of pixel electrodes respectively connected thereto is arranged along an extension direction of the source bus line and alternately disposed on one side and then another side in an arrangement direction of the source bus line, wherein each of the plurality of thin film transistors includes a semiconductor layer having a source portion, a channel portion, and a drain portion, and a gate electrode formed by a portion of the gate bus line, wherein the source portion, the channel portion, and the drain portion are arranged so as to be adjacent to one another in a direction perpendicular to the arrangement direction of the plurality of source bus lines, and wherein the gate electrode extends in a direction parallel to the arrangement direction of the plurality of source bus lines, and is arranged to face the channel portion.

(2) In the liquid crystal display device according to a second aspect of the present invention, the semiconductor layer may include a channel region that functions as the channel portion, high-concentration impurity regions that respectively function as the source portion and the drain portion, and low-concentration impurity regions provided between the channel region and the high-concentration impurity regions, and in each of the plurality of thin film transistors, a length of the low-concentration impurity region in the extension direction of the source bus lines may remain unchanged upon a shift in relative position of the plurality of gate bus lines and the plurality of thin film transistors in the arrangement direction of the plurality of source bus lines.

(3) The liquid crystal display device of (1) or (2) above, wherein each of the plurality of thin film transistors may have a multi-gate structure having a plurality of the gate electrodes each formed by a portion of the gate bus line, the plurality of gate electrodes being arranged along the gate bus line.

(4) The liquid crystal display device of (3) above, wherein each of the plurality of thin film transistors may have a double gate structure with the gate electrodes being respectively arranged in two locations along the gate bus line.

(5) The liquid crystal display device of (3) above, wherein each of the plurality of thin film transistors may have a triple gate structure with the gate electrodes being respectively arranged in three locations along the gate bus line.

(6) The liquid crystal display device of (1) or (2) above, wherein each of the plurality of thin film transistors may have a single gate structure having the gate electrode that is formed by a portion of the gate bus line being arranged along the gate bus line.

(7) The liquid crystal display device according to any one of (1) to (6) above, wherein holding characteristics of each of the plurality of thin film transistors may remain unchanged upon a shift in relative positions of the plurality of gate bus lines and the plurality of thin film transistors in the arrangement direction of the plurality of source bus lines.

(8) The liquid crystal display device according to any one of (1) to (7) above, wherein, when a region partitioned by adjacent the source bus lines and adjacent the gate bus lines is designated as a single pixel, an arrangement of a plurality of the pixels may be a stripe arrangement.

(9) The liquid crystal display device according to any one of (1) to (7) above, wherein, when a region partitioned by adjacent the source bus lines and adjacent the gate bus lines is designated as a single pixel, an arrangement of a plurality of the pixels may be a delta arrangement.

(10) The liquid crystal display device according to any one of (1) to (9) above, wherein the semiconductor layer may include an oxide material formed from indium, gallium, and zinc.

### Effects of the Invention

According to the present invention, a liquid crystal display device capable of suppressing variation in the holding characteristics of the thin-film transistors and thus suppress deterioration in display quality can be provided.

### BRIEF DESCRIPTION OF THE DRAWINGS

FIG. 1 is a schematic view showing a liquid crystal display device according to Embodiment 1 of the present invention.

FIG. 2 is a plan view showing an enlargement of a main portion of the liquid crystal display device according to Embodiment 1 of the present invention.

FIG. 3 is cross-sectional view along the line A-A in FIG. 2.

FIG. 4A is a plan view showing an enlargement of a main portion of a liquid crystal display device according to a comparison example.

FIG. 4B is a plan view showing an enlargement of a main portion of a liquid crystal display device according to a comparison example.

FIG. 5A is a plan view showing an enlargement of a main portion of the liquid crystal display device according to Embodiment 1 of the present invention.

FIG. 5B is a plan view showing an enlargement of a main portion of the liquid crystal display device according to Embodiment 1 of the present invention.

FIG. 6A is a schematic view for explaining effects of the liquid crystal display device according to Embodiment 1 of the present invention.

FIG. 6B is a schematic view for explaining effects of the liquid crystal display device according to Embodiment 1 of the present invention.

FIG. 7 is a plan view showing an enlargement of a main portion of the liquid crystal display device according to Embodiment 2 of the present invention.

FIG. 8 is a plan view showing an enlargement of a main portion of the liquid crystal display device according to Embodiment 3 of the present invention.

FIG. 9 is a plan view showing an enlargement of a main portion of the liquid crystal display device according to Embodiment 4 of the present invention.

FIG. 10 is a plan view showing an enlargement of a main portion of the liquid crystal display device according to Embodiment 5 of the present invention.

### DETAILED DESCRIPTION OF EMBODIMENTS

### Embodiment 1

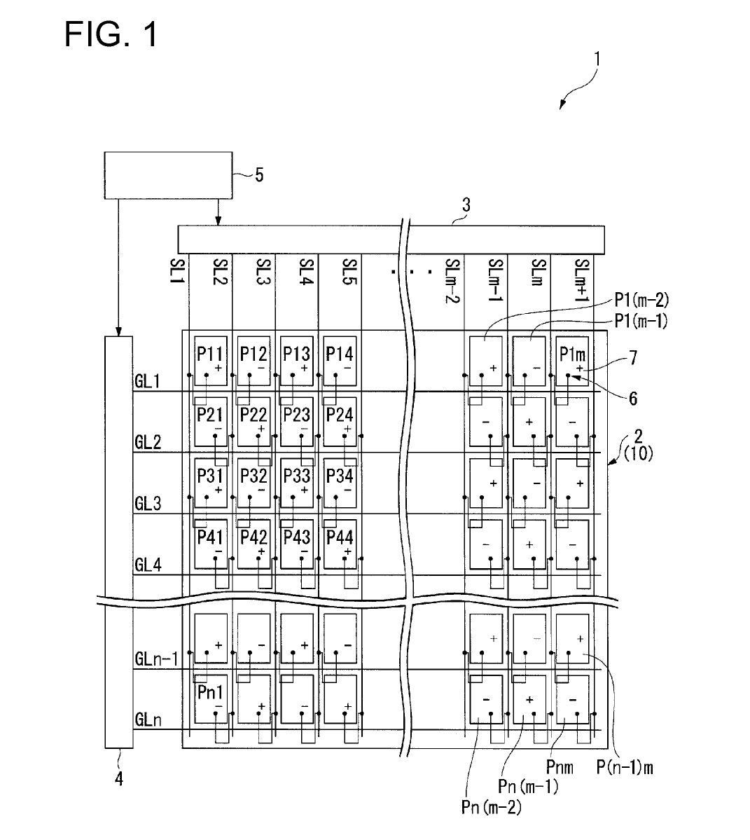

Embodiment 1 of the present invention will be explained below with reference to FIGS. 1 to 6B.

Note that in the all of the figures below, dimensions have been scaled differently depending on the component in order to facilitate viewing of the various configuration elements.

FIG. 1 is a schematic view showing a liquid crystal display device 1 according to Embodiment 1 of the present invention.

As illustrated in FIG. 1, a liquid crystal display device 1 according to the present embodiment includes a liquid crystal panel 2, a source driver 3, a gate driver 4, and a controller 5. The liquid crystal panel 2 includes an element substrate 10.

On the element substrate 10, multiple pixels, which represent the minimum area of display, are arranged in a matrix. The element substrate 10 is provided with a plurality of source bus lines (SL1 to SLm+1), a plurality of gate bus lines (GL1 to GLn), a plurality of thin film transistors 6 (hereinafter abbreviated to TFTs) and a plurality of pixel electrodes 7. In the following explanation, the elements generally referred to as source bus lines are sometimes described as source bus lines SL. Also, the elements generally referred to as gate bus lines are sometimes collectively referred to as a gate bus line GL.

The plurality of source bus lines (SL1 to SLm+1) is adjacently arranged so that the source bus lines extend parallel to one another. The plurality of gate bus lines (GL1 to GLn) is adjacently arranged so that the gate bus lines extend parallel to one another and so as to be perpendicular to the plurality of the source bus lines (SL1 to SLm+1). The plurality of source bus lines (SL1 to SLm+1) and the plurality of gate bus lines (GL1 to GLn) form a grid pattern on the element substrate 10. Single pixels P are formed by the rectangular regions partitioned by adjacent source bus lines SL and adjacent gate bus lines GL. In the present embodiment, a plurality of pixels (P11 to Pnm) is arranged in a matrix.

Also, in the present embodiment, the plurality of pixels (P11 to Pnm) is arranged in a stripe arrangement. Specifically, the plurality of pixels (P11 to Pnm) is arranged in a stripe pattern with stripes extending along an extension direction of the source bus lines SL.

The plurality of TFTs 6 is provided in correspondence to intersections of the source bus lines (SL1 to SLm+1) and the plurality of gate bus lines (GL1 to GLn). The TFTs 6 supply image signals from the source bus lines SL to the pixel electrodes 7 in response to a scan signal from the gate bus lines GL. The TFTs 6 are described in more detail in a later section.

The plurality of pixel electrodes 7 is provided in correspondence with the plurality of TFTs 6. A plurality of pixel electrodes 7 is connected to each line of the plurality of source bus lines (SL1 to SLm+1). The plurality of pixel electrodes 7 connected to a single source bus line SL is arranged along a extension direction of the source bus lines SL (hereinafter referred to as a vertical line direction) and alternately to one side (left side in FIG. 1) and then the other (right side in FIG. 1) in an arrangement direction of the plurality of source bus lines (SL1 to SLm+1) (hereinafter referred to as horizontal line direction).

In the present embodiment, the odd-numbered pixel electrodes 7 connected to the odd-numbered gate bus lines (GL1, GL3, GL5, . . . ) in the vertical line direction are connected to adjacent source bus line (SLi) (where i is a positive integer) on the left side. On the other hand, the even-numbered pixel electrodes 7 connected to the even-numbered gate bus lines (GL2, GL4, GL6, . . . ) in the vertical line direction are connected to adjacent source bus lines (SLi+1) on the right side.

The plurality of pixel electrodes 7 is supplied with image signals by the source bus lines SL via the TFTs 6. The pixel electrodes 7 drive liquid crystal positioned between the common electrode (not shown in the figures) in response to the image signals with light transmittance being adjusted accordingly.

The controller 5 supplies the image signal to the source driver 3. The controller 5 supplies control signals to the gate driver 4 and the source driver 3.

The control signals supplied to the gate driver 4 include a gate start pulse (GSP), a gate shift clock signal (GSC), and a gate output enable (GOE).

The control signals supplied to the source driver 3 include a source start pulse (SSP), a source shift clock signal (SSC), a source output enable signal (SOE) and a polarity control signal (POL).

The gate driver 4 supplies the scan signal sequentially to the gate bus lines (GL1 to GLn) in GL1, GL2, GL3, . . . GLn order. In response to the scan signal, the TFT 6 is driven in horizontal line units.

The source driver 3 converts the supplied image signal into an analog image signal. The source driver 3 supplies the image signals for one of the horizontal lines to the plurality of source bus lines (SL1 to SLm+1) for each horizontal interval over which the scan signal is supplied to the corresponding gate bus line GL.

The source driver 3 supplies the image signals in column inversion format. The image signals supplied to the plurality of source bus lines (SL1 to SLm+1) are arranged so that adjacent source bus lines SL have opposing polarity. Specifically, image signals of opposing polarity are supplied to the odd-numbered source bus lines (SL1, SL3, . . . ) and even-numbered source bus lines (SL2, SL4, . . . ) in the horizontal line direction. The polarity of the image signals supplied to the plurality of source bus lines (SL1 to SLm+1) is inverted frame-by-frame by the controller 5.

In FIG. 1, a state is illustrated in which image signals of positive potential are being supplied to the odd-numbered source bus lines (SL1, SL3, . . . ) in the horizontal line direction and image signals of negative potential are being supplied to the even-numbered source bus lines (SL2, SL4, . . . ) in the horizontal line direction. The source driver 3 supplies the image signals for which the polarity reverses between positive and negative potential to each of the plurality of source bus lines (SL1 to SLm+1) at every unit interval (1 vertical scanning interval).

Thus, the liquid crystal display device 1 according to the present embodiment makes use of the Z-inversion method, whereby the pixel electrodes 7 are driven using the dot inversion method while the source bus lines SL are driven using the column inversion method.

In the following, a specific configuration of the liquid crystal panel 2 is explained.

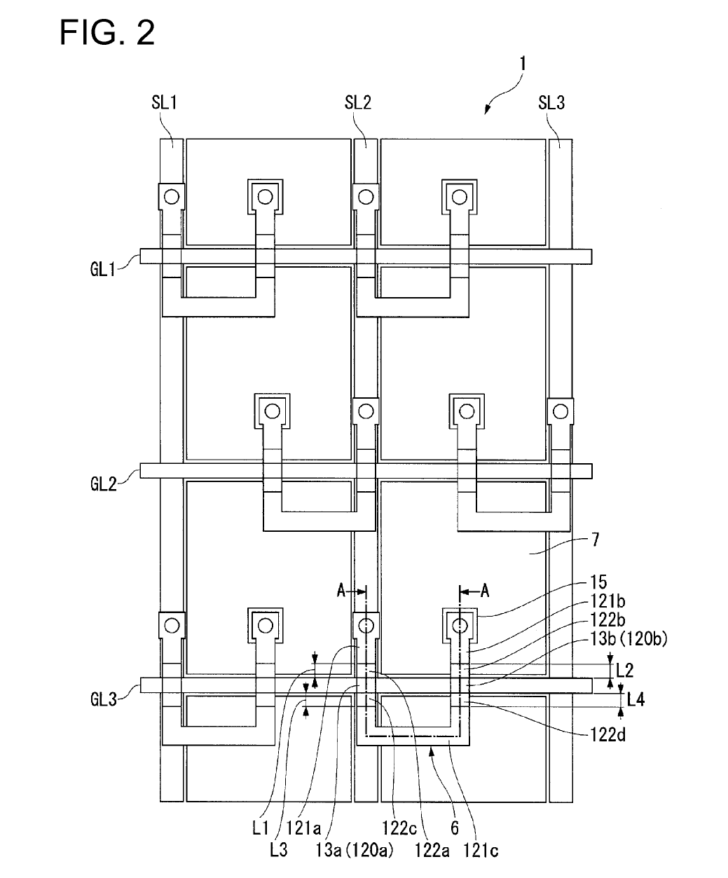

FIG. 2 is a plan view showing an enlargement of a main portion of the liquid crystal display device 1 according to the present embodiment.

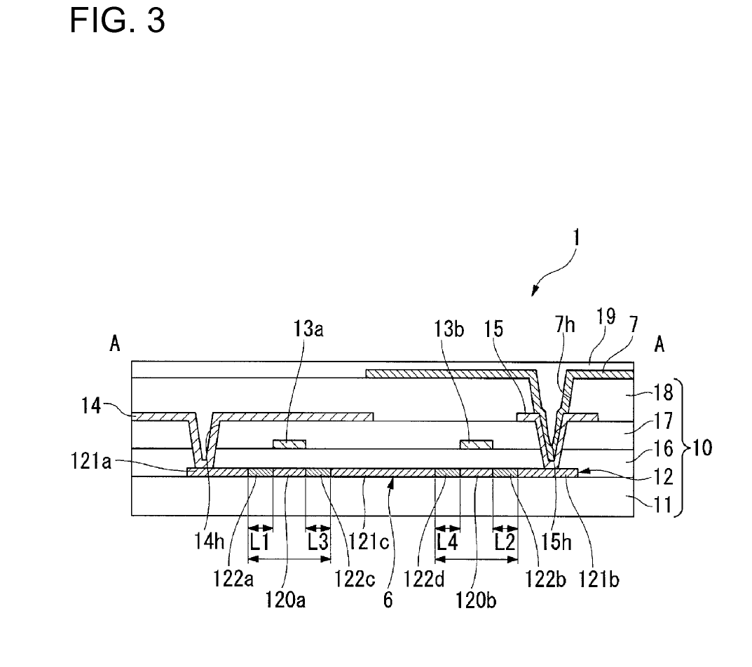

FIG. 3 is a cross-sectional view along the line A-A in FIG. 2. FIG. 2 shows an enlargement of part of the area partitioned by the plurality of source bus lines (SL1 to SLm+1) and the plurality of gate bus lines (GL1 to GLn), the illustrated part being partitioned by the 3 source bus lines (SL1 to SL3) and the 3 gate bus lines (GL1 to GL3).

Although the explanation below takes as an example a transmissive liquid crystal panel of the active matrix format, the liquid crystal panels to which the present invention can be applied are not limited to the transmissive liquid crystal panels having the active matrix type. For instance, the present invention may also be applied to a transflective (combined transmissive and reflective-type) liquid crystal panel or the like.

The liquid crystal panel 2 includes the element substrate 10 (see FIG. 3), a color filter substrate (not shown in the drawings) and a liquid crystal layer (not shown in the drawings). The liquid crystal panel 2 of the present embodiment performs display functions using, for example, a Twisted Nematic (TN) mode. In the liquid crystal layer, liquid crystals having a positive dielectric anisotropy are used.

The liquid crystal display device 1 of the present invention is not limited to using the above-described TN mode as a display mode, and may use a Vertical Alignment (VA) mode, a Super Twisted Nematic (STN) mode, an In-Plane Switching (IPS) mode, a Fringe Field Switching (FFS) mode or the like. Note, however, that the present embodiment provides an example in which a TN liquid crystal panel 2 is used.

As shown in FIG. 3, the TFTs 6 are formed on a transparent substrate 11, which forms a portion of the element substrate 10. The TFT 6 includes a semiconductor layer 12, a first gate electrode 13a, and a second gate electrode 13b. The TFT 6 of the present embodiment is of the n-channel type. However, the TFT 6 is not limited to being of the n-channel type and may be of the p-channel type.

For the transparent substrate 11, a glass substrate or the like can be used, for example. As a formation material to form the semiconductor layer 12, a silicon semiconductor such as Continuous Grain Silicon (CGS), Low-temperature Poly-Silicon (LPS), Amorphous Silicon (a-Si), or the like can be used.

The semiconductor layer 12 includes a first channel region 120a, a second channel region 120b, a first high-concentration impurity region 121a, a second high-concentration impurity region 121b, a third high-concentration impurity region 121c, a first low-concentration impurity region 122a, a second low-concentration impurity region 122b, a third low-concentration impurity region 122c, and a fourth low-concentration impurity region 122d.

The first channel region 120a and the second channel region 120b function as a channel portion of the semiconductor layer 12. The first high-concentration impurity region 121a functions as a source portion of the semiconductor layer 12. The second high-concentration impurity region 121b functions as a drain portion of the semiconductor layer 12.

As shown in FIG. 2, the first gate electrode 13a and the second gate electrode 13b are formed by portions of the gate bus lines GL. The TFT 6 has a double gate structure in which the first gate electrode 13a and the second gate electrode 13b are arranged along the gate bus line GL. The TFT 6 is formed to have a U-shape when seen in plan view.

As shown in FIG. 2 and FIG. 3, the first high-concentration impurity region 121a and the first channel region 120a are arranged to be adjacent with each other across the first low-concentration impurity region 122a in a direction perpendicular to the horizontal line direction. The second high-concentration impurity region 121b and the second channel region 120b are arranged to be adjacent with each other across the second low-concentration impurity region 122b in the direction perpendicular to the horizontal line direction.

Hence, the holding characteristics of the plurality of TFTs 6 are not altered by any shift in the relative positions of the plurality of gate bus lines GL and plurality of TFTs 6 in the horizontal line direction.

Here, “holding characteristics” refers to the extent to which electric charge stored by pixel capacitance can be retained in a period between application of a prescribed signal voltage to a given pixel electrode 7 and application of a new signal voltage to the same pixel electrode 7 (that is, 1 frame period).

Holding characteristics vary according to the shift in relative position of the gate electrode and the semiconductor layer. The holding characteristics in the present embodiment therefore vary according to the shift in relative position of the gate electrode and the channel region and low-concentration impurity regions. In the present embodiment, however, a shift of the gate bus line GL in the horizontal line direction does not result in a shift in the relative positions of the gate electrode and the semiconductor layer, and so the holding characteristics of the TFT 6 will not change.

As shown in FIG. 2, the first gate electrode 13a extends parallel to the horizontal line direction. As shown in FIG. 3, the first channel region 120a is arranged below the first gate electrode 13a and so as to oppose the first gate electrode 13a. The first channel region 120a is formed within the semiconductor layer 12 so as to be self-aligned with respect to the first gate electrode 13a. The first channel region 120a is doped with a p-type impurity such as boron (B).

As shown in FIG. 2, the second gate electrode 13b extends parallel to the horizontal line direction. As shown in FIG. 3, the second channel region 120b is arranged below the second gate electrode 13b and so as to oppose the second gate electrode 13b. The second channel region 120b is formed within the semiconductor layer 12 so as to be self-aligned with respect to the second gate electrode 13b. The second channel region 120b is doped with a p-type impurity similar to that of the first channel region 120a.

The first high-concentration impurity region 121a and the second high-concentration impurity region 121b are provided across a gap with the first channel region 120a and the second channel region 120b therebetween. The first high-concentration impurity region 121a is provided closer to a source electrode 14 than the first channel region 120a. The second high-concentration impurity region 121b is provided closer to a drain electrode 15 than the second channel region 120b. The third high-concentration impurity region 121c is provided between the first channel region 120a and the second channel region 120b.

The first high-concentration impurity region 121a, the second high-concentration impurity region 121b, and the third high-concentration impurity region 121c each have a higher concentration of n-type impurities than the low-concentration impurity regions. Hence, in the first high-concentration impurity region 121a, the second high-concentration impurity region 121b, and the third high-concentration impurity region 121c, the n-type carrier concentration is higher than that in the low-concentration impurity regions.

The first low-concentration impurity region 122a is provided between the first channel region 120a and the first high-concentration impurity region 121a. The second low-concentration impurity region 122b is provided between the second channel region 120b and the second high-concentration impurity region 121b. The third low-concentration impurity region 122c is provided between the first channel region 120a and the third high-concentration impurity region 121c. The fourth low-concentration impurity region 122d is provided between the second channel region 120b and the third high-concentration impurity region 121c.

The first low-concentration impurity region 122a, the second low-concentration impurity region 122b, the third low-concentration impurity region 122c, and the fourth low-concentration impurity region 122d each contain a lower concentration of n-type impurities than the high-concentration impurity regions. Hence, in the first low-concentration impurity region 122a, the second low-concentration impurity region 122b, the third low-concentration impurity region 122c and the fourth low-concentration impurity region 122d, the n-type carrier concentration is lower than that in the high-concentration impurity regions.

Thus, the first high-concentration impurity region 121a and first low-concentration impurity region 122a, the second high-concentration impurity region 121b and second low-concentration impurity region 122b, the third high-concentration impurity region 121c and third low-concentration impurity region 122c, and the third high-concentration impurity region 121c and fourth low-concentration impurity region 122d are each formed with a Lightly Doped Drain (LDD) structure.

On the transparent substrate 11, a gate insulating film 16 is formed so as to cover the semiconductor layer 12.

As a formation material of the gate insulating film 16, a silicon oxide film, a silicon nitride film, a multilayer film combining these, or the like can be used.

In FIG. 2 and FIG. 3, a length of the first low-concentration impurity region 122a in the vertical line direction is specified as a first length L1. A length of the second low-concentration impurity region 122b in the vertical line direction is specified as a second length L2. A length of the third low-concentration impurity region 122c in the vertical line direction is specified as a third length L3. A length of the fourth low-concentration impurity region 122d in the vertical line direction is specified as a fourth length L4.

The first length L1 and the third length L3 are not changed by a shift in the relative positions of the plurality of gate bus lines GL and the plurality of TFTs 6 in the horizontal line direction. Further, the second length L2 and the fourth length L4 are not changed by a shift in the relative positions of the plurality of gate bus lines GL and the plurality of TFTs 6 in the horizontal line direction.

On the gate insulating film 16, the first gate electrode 13a is formed in a position opposing the first channel region 120a of the semiconductor layer 12. The second gate electrode 13b is formed in a position opposing the second channel region 120b of the semiconductor layer 12. As a formation material of the first gate electrode 13a and second gate electrode 13b, a multilayer film of tungsten (W)/tantalum nitride (TaN), or molydenum (Mo), titanium (Ti), aluminum (Al) or the like can, for example, be used.

On the gate insulating film 16, a first interlayer insulating film 17 is formed so as to cover the first gate electrode 13a and the second gate electrode 13b. As a formation material of the first interlayer insulating film 17, a silicon oxide film, a silicon nitride film, a multilayer film combining these, or the like can be used.

On the first interlayer insulating film 17, the source electrode 14 and the drain electrode 15 are formed. The source electrode 14 is connected to the first high-concentration impurity region 121a of the semiconductor layer 12 via a contact hole 14h that pierces the first interlayer insulating film 17 and the gate insulating film 16. The drain electrode 15 is connected to the second high-concentration impurity region 121b of the semiconductor layer 12 via a contact hole 15h that pierces the first interlayer insulating film 17 and the gate insulating film 16. As a formation material of the source electrode 14 and the drain electrode 15, a formation material with similar conductivity to the above-described gate electrode 13 can be used.

On the first interlayer insulating film 17, a second interlayer insulating film 18 is formed so as to cover the source electrode 14 and the drain electrode 15. As a formation material of the second interlayer insulating film 18, a formation material similar to the above-described first interlayer insulating film 17 or an organic insulating material can be used.

On the second interlayer insulating film 18, the pixel electrodes 7 are formed. The pixel electrode 7 is connected to the drain electrode 15 via a contact hole 7h that pierces the second interlayer insulating film 18. The pixel electrode 7 is connected to the second high-concentration impurity region 121b of the semiconductor layer 12 with the drain electrode 15 as a relay electrode.

As a formation material of the pixel electrode 7, a transparent conductive material such as indium tin oxide (ITO) or indium zinc oxide (IZO) can, for example, be used.

With such a configuration, when the TFT 6 is turned on after being supplied with the scan signal via the gate bus line GL, the image signal supplied to the source electrode 14 via the source bus line SL is supplied to the pixel electrode 7 by way of the semiconductor layer 12 and the drain electrode 15.

On the second interlayer insulating film 18, an alignment film 19 is formed so as to cover the pixel electrode 7. The alignment film 19 provides an orientation regulating force that causes the liquid crystal molecules forming the liquid crystal layer to be horizontally oriented. The TFT 6 may be a top gate-type TFT or a bottom gate-type TFT.

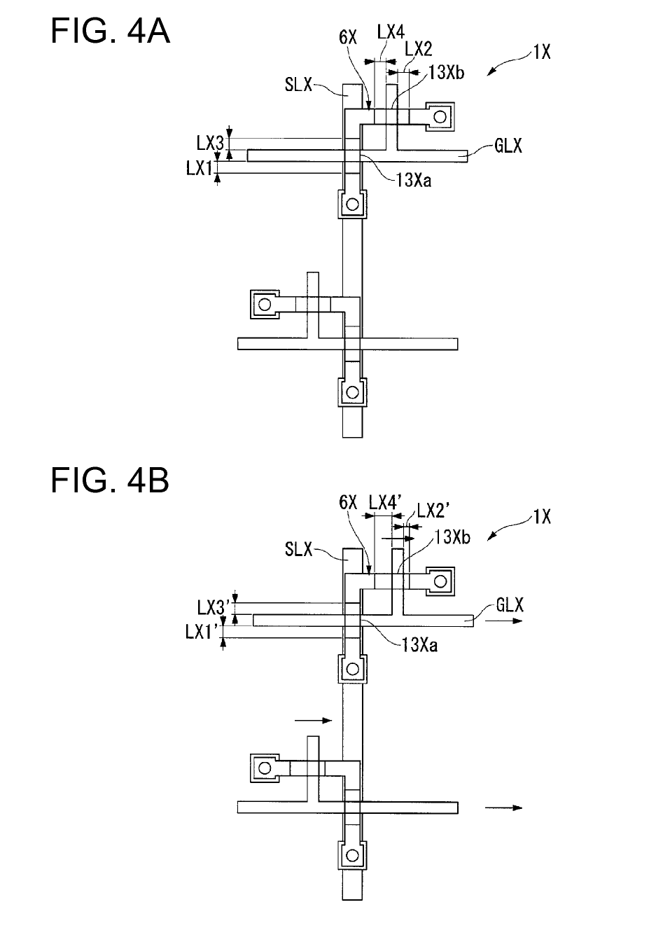

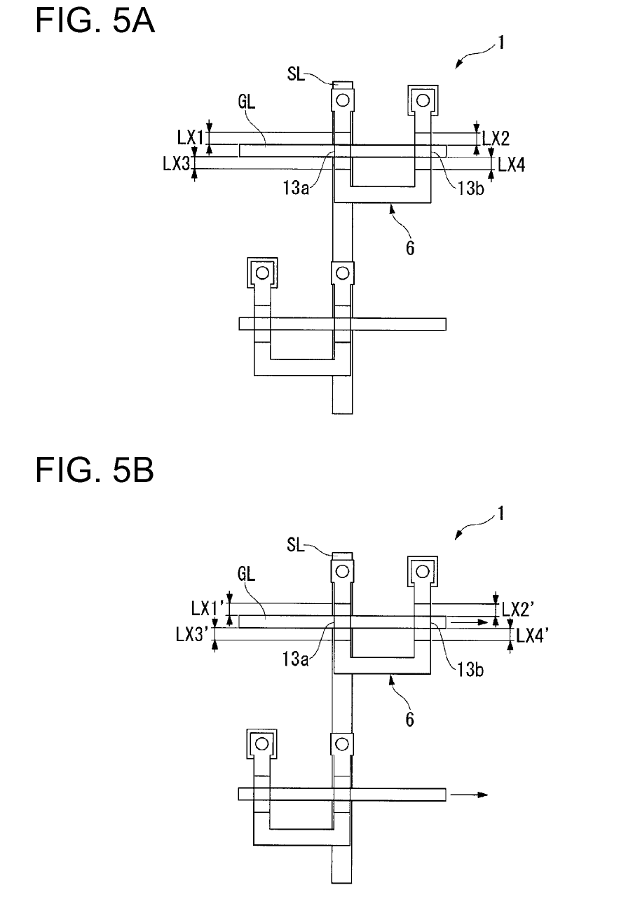

FIGS. 4A to 5B are schematic views for explaining effects of the arrangement of the TFT 6 in the liquid crystal display device 1 of the present embodiment.

FIGS. 4A and 4B are plan views showing an enlargement of a main portion of a liquid crystal display device 1X according to a comparison example. FIG. 4A is a view prior to occurrence of the shift in relative positions, which is to say misalignment, of the plurality of gate bus lines and the plurality of TFTs in the horizontal line direction. FIG. 4B is a view from after the misalignment in the horizontal line direction has occurred.

In FIG. 4A, the reference characters LX1, LX2, LX3 and LX4 respectively denote lengths prior to the occurrence of misalignment in the horizontal line direction. Specifically, LX1 is a length in the vertical line direction of a first low-concentration impurity region (first length), LX2 is a length in the vertical line direction of a second low-concentration impurity region (second length), LX3 is a length in the horizontal line direction of a third low-concentration impurity region (third length), and LX4 is a length in the horizontal line direction of a fourth low-concentration impurity region (fourth length).

In FIG. 4B, the reference characters LX1′, LX2′, LX3′ and LX4′ respectively denote the first length, second length, third length and fourth length after the occurrence of misalignment in the horizontal line direction.

FIGS. 5A and 5B are plan views showing an enlargement of a main portion of the liquid crystal display device 1 according to the present embodiment. FIG. 5A is a view from before the misalignment in the horizontal line direction has occurred. FIG. 5B is a view from after the misalignment in the horizontal line direction has occurred.

In FIG. 5A, the reference characters L1, L2, L3 and L4 respectively denote the first length, second length, third length and fourth length before the occurrence of misalignment in the horizontal line direction.

In FIG. 5B, the reference characters L1′, L2′, L3′ and L4′ respectively denote the first length, second length, third length and fourth length after the occurrence of misalignment in the horizontal line direction.

As illustrated in FIG. 4A, a TFT 6X of the liquid crystal display device 1X according to the comparison example includes a first gate electrode 13Xa and a second gate electrode 13Xb. The first gate electrode 13Xa and the second gate electrode 13Xb are each formed by a part of the gate bus line GLX.

The TFT 6X has a double gate structure in which the first gate electrode 13Xa and the second gate electrode 13Xb are arranged along the gate bus line GLX. The TFT 6X is formed to have an L-shape when seen in plan view.

The first gate electrode 13Xa extends in a direction parallel to the horizontal line direction. The second gate electrode 13Xb extends in a direction perpendicular to the horizontal line direction. A portion of the gate bus line GLX projects upwards, extending parallel to the extension direction of the source bus line SLX.

The second gate electrode 13Xb is formed by a portion of the projection of the source bus line SLX.

Let us consider the case that a misalignment occurs in the horizontal line direction in the liquid crystal display device 1X. As illustrated in FIG. 4A and FIG. 4B, there is no change between before and after the occurrence of the horizontal line direction misalignment in the first length LX, LX1′ or the third length LX3, LX3′ (LX1=LX1′ and LX3=LX3′).

On the other hand, the second length LX2′ after the misalignment in the horizontal line direction has occurred is shorter than the second length LX2 before the misalignment in the horizontal line direction (LX2′<LX2). Also, the fourth length LX4′ after the misalignment in the horizontal line direction has occurred is longer than the fourth length LX4 before the misalignment in the horizontal line direction (LX4′>LX4).

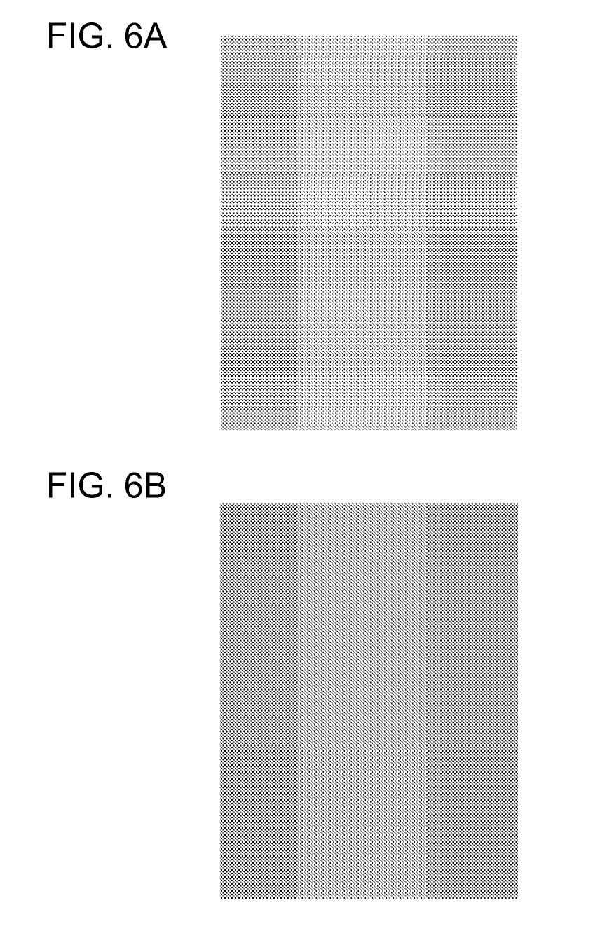

Thus, when the second length LX2/LX2′ and fourth length LX4/LX4′ changes before/after the occurrence of the misalignment in the horizontal line direction, the holding characteristics of the TFT 6X are altered, causing a loss of display quality. When the holding characteristics of the TFT 6X change, uneven streaks become noticeable in the displayed image due to differences in the shading of each horizontal line, as illustrated in FIG. 6A.

By contrast, in the present embodiment, as shown in FIG. 5A and FIG. 5B, the first length L1/L1′, the second length L2/L2′, the third length L3/L3′ and the fourth length L4/L4′ remain unaltered before/after the occurrence of misalignment in the horizontal line direction (L1=L1′, L2=L2′, L3=L3′, and L4=L4′). Hence, the holding characteristics of the TFTs 6 do not change before/after the misalignment in the horizontal line direction has occurred, and deterioration in display quality can be suppressed. When the holding characteristics of the TFT 6 remain unaltered, the occurrence of differences in the shading of each horizontal line is suppressed, with the result that uneven streaks become less apparent, as illustrated in FIG. 6B.

In the liquid crystal display device 1 described above, the Z-inversion method is employed. As a result, power consumption can be reduced in comparison to when the dot inversion method is used. In the Z-inversion method, the polarity arrangement applied to the pixel is in a dot-inverted state. Hence, occurrence of crosstalk between pixels can be suppressed and flicker can be reduced.

With the Z-inversion method, variation in the holding characteristics is easily generated between the pixels connected to the right and left sides of the source bus lines SL by a misalignment in the horizontal line direction. However, in the present embodiment, the source portion, channel portion, and drain portion of the semiconductor layer are arranged in the vertical line direction and the gate electrodes extend in a direction parallel of the horizontal line direction. As a result, even if misalignment were to occur in the horizontal line direction, variation in the holding characteristics of the TFTs 6 would be suppressed, making it possible to suppress deterioration of display quality.

It is to be noted that although in the present embodiment an example was described in which the TFT had a double gate structure, the present invention is not limited to this arrangement. For example, the present invention can also be applied when the TFT has a multi-gate structure, such as a triple gate structure, a four gate structure, or the like.

### Embodiment 2

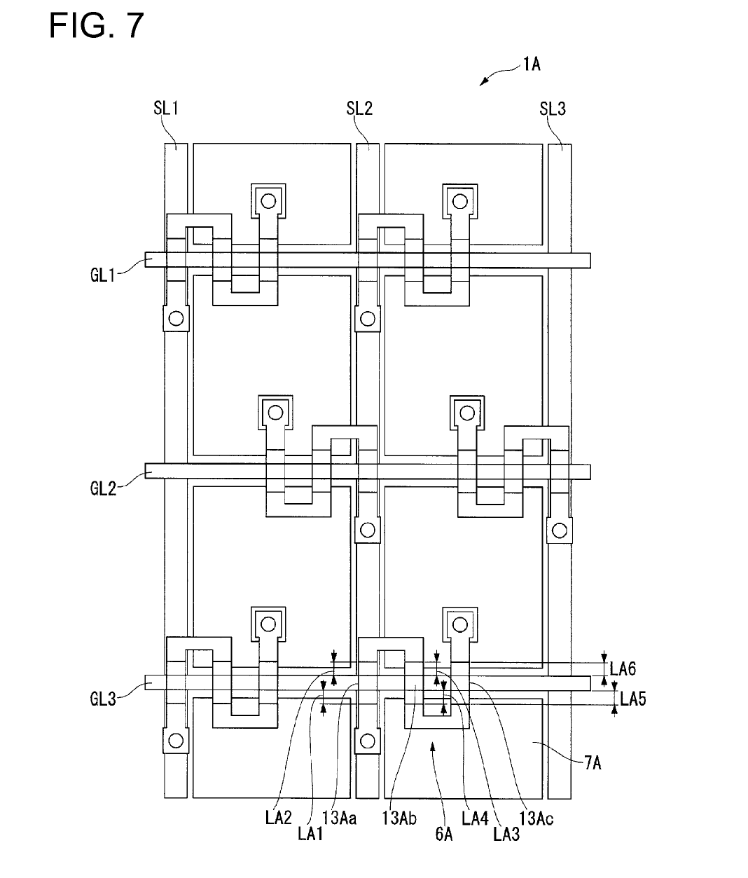

Embodiment 2 of the present invention will be explained below with reference to FIG. 7. The basic configuration of a liquid crystal display device 1A according to the present embodiment is similar to that of Embodiment 1, but differs in that TFTs 6A have a triple gate structure. Hence, in the present embodiment, the structure of the TFT 6A is explained while explanation of the basic configuration of the liquid crystal display device 1A is omitted.

FIG. 7 is a plan view showing an enlargement of a main portion of the liquid crystal display device 1A according to the present embodiment. FIG. 7 shows an enlargement of part of the area partitioned by the plurality of source bus lines (SL1 to SLm+1) and the plurality of gate bus lines (GL1 to GLn), the illustrated part being partitioned by the 3 source bus lines (SL1 to SL3) and the 3 gate bus lines (GL1 to GL3).

In FIG. 7 the same reference characters are used to denote elements common to the figures for Embodiment 1, and detailed explanations of these elements are omitted.

In Embodiment 1, the TFT 6 had a double gate structure and was formed to have a U-shape when seen in plan view. By contrast, the TFT 6A of the present embodiment has a triple gate structure and has S-shape when seen in plan view.

The TFT 6A includes a first gate electrode 13Aa, a second gate electrode 13Ab, and a third gate electrode 13Ac. The first gate electrode 13Aa, the second gate electrode 13Ab, and the third gate electrode 13Ac each extend in a direction parallel to the horizontal line direction. The TFT 6A has a triple gate structure in which the first gate electrode 13Aa, the second gate electrode 13Ab, and the third gate electrode 13Ac are arranged along the gate bus line GL.

In FIG. 7, the reference characters LA1, LA2, LA3, LA4, LA5 and LA6 denote a first length, a second length, a third length, a fourth length, a fifth length, and a sixth length respectively.

In the present embodiment, the first length LA1, the second length LA2, the third length LA3, the fourth length LA4, the fifth length LA5, and the sixth length LA6 each remain unchanged before and after the occurrence of misalignment in the horizontal line direction.

According to the liquid crystal display device 1A of the present embodiment, even if misalignment occurs in the horizontal line direction of the TFTs 6A with the triple gate structure, variation in the holding characteristics of the TFTs 6A is suppressed, making it possible to suppress deterioration in display quality.

### Embodiment 3

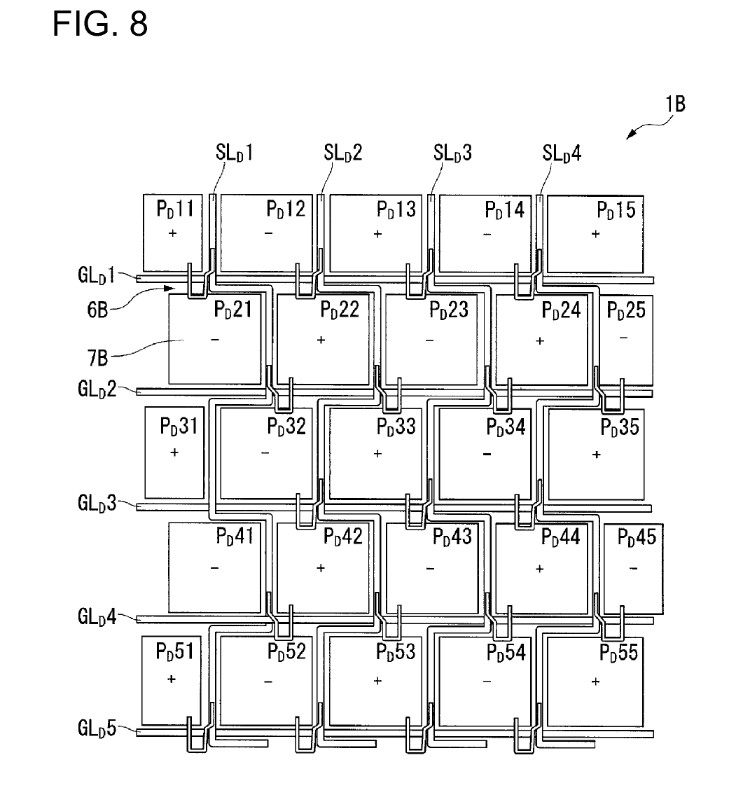

Embodiment 3 of the present invention will be explained below with reference to FIG. 8.

The basic configuration of a liquid crystal display device 1B according to the present embodiment is similar to that of Embodiment 1, but differs in that the pixel arrangement is a delta arrangement. Hence, in the present embodiment, the delta arrangement is explained while explanation of the basic configuration of the liquid crystal display device 1B is omitted.

FIG. 8 is a plan view showing an enlargement of a main portion of the liquid crystal display device 1B according to the present embodiment. FIG. 8 shows an enlargement of part of the area partitioned by the plurality of source bus lines (SLD1 to SLDm+1) and the plurality of gate bus lines (GLD1 to GLDn), the illustrated part being partitioned by the 4 source bus lines (SLD1 to SLD4) and the 5 gate bus lines (GLD1 to GLD5).

In FIG. 8 the same reference characters are used to denote elements common to the figures for Embodiment 1, and detailed explanations of these elements are omitted.

Also, in Embodiment 1, the plurality of pixels was arranged in a stripe arrangement. In contrast, in the present embodiment, as shown in FIG. 8, a plurality of pixels (PD11 to PD55) is arranged in a delta arrangement. Specifically, the pixels of odd-numbered rows and the pixels of even-numbed rows are positioned with a half-pixel offset. For example, a center position of a second pixel PD32 from a row end (left) of the third row is offset by exactly half of one pixel width to the left side in the row direction (left-right direction) with respect to a center position of a second pixel PD22 from a row end of the second row. The center position of the second pixel PD32 from the row end of the third row matches, in the row direction, a center position of a second pixel PD12 from a row end of a first row and a center position of a second pixel PD52 from a row end of a fifth row. Further, the center position of the second pixel PD22 from the row end of the second row matches, in the row direction, a center position of a second pixel PD42 from a row end of a fourth row.

In the present embodiment, the source bus lines SLD have a zig-zag form when seen in plan view. The pixel electrodes 7B have a square form when seen in plan view.

In the present embodiment, the odd-numbered pixel electrodes 7B connected to the odd-numbered gate bus lines (GLD1, GLD3, GLD5, . . . ) in the vertical line direction are connected to an adjacent source bus line (SLDi+1) (where i is a positive integer) on the right side. On the other hand, the even-numbered pixel electrodes 7B connected to the even-numbered gate bus lines (GLD2, GLD4, . . . ) in the vertical line direction are connected to adjacent source bus lines (SLDi) on the left side.

According to the liquid crystal display device 1B of the present embodiment, the pixel arrangement is a delta arrangement, and, even if misalignment occurs in the horizontal line direction of the TFTs 6B with the double gate structure, variation in the holding characteristics of the TFTs 6B is suppressed, making it possible to suppress deterioration in display quality.

### Embodiment 4

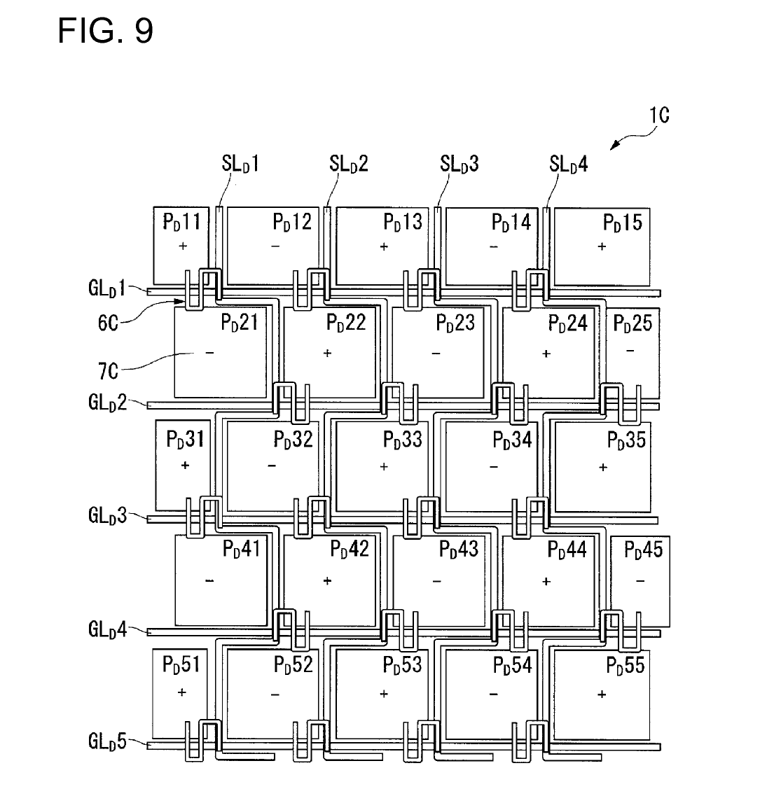

Embodiment 4 of the present invention will be explained below with reference to FIG. 9. The basic configuration of a liquid crystal display device 1C according to the present embodiment is similar to that of Embodiment 3, but differs from Embodiment 3 in that TFTs 6C have a triple gate structure. Hence, in the present embodiment, explanation of the basic configuration of the liquid crystal display device 1C is omitted.

FIG. 9 is a plan view showing an enlargement of a main portion of the liquid crystal display device 1C according to the present embodiment. FIG. 9 shows an enlargement of part of the area partitioned by the plurality of source bus lines (SLD1 to SLDm+1) and the plurality of gate bus lines (GLD1 to GLDn), the illustrated part being partitioned by the 4 source bus lines (SLD1 to SLD4) and the 5 gate bus lines (GLD1 to GLD5).

In FIG. 9 the same reference characters are used to denote the elements common to the figures for Embodiment 3, and detailed explanations of these elements are omitted.

According to the liquid crystal display device 1C of the present embodiment, the pixel arrangement is a delta arrangement, and, even if misalignment occurs in the horizontal line direction of the TFTs 6C with the triple gate structure, variation in the holding characteristics of the TFTs 6C is suppressed, making it possible to suppress deterioration in display quality.

### Embodiment 5

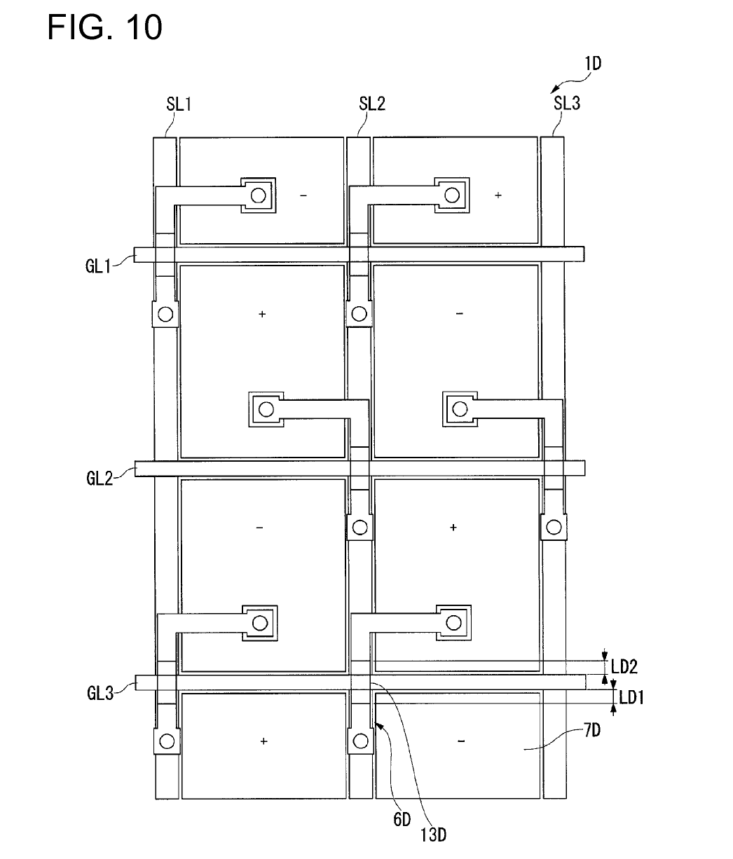

Embodiment 5 of the present invention will be explained below with reference to FIG. 10.

The basic configuration of a liquid crystal display device 1D of the present embodiment is similar to that of Embodiment 1, but differs from Embodiment 1 in that TFTs 6D have a single gate structure. Hence, in the present embodiment, the structure of the TFTs 6D is explained while explanation of the basic configuration of the liquid crystal display device 1D is omitted.

FIG. 10 is a plan view showing an enlargement of a main portion of the liquid crystal display device 1D of the present embodiment. FIG. 10 shows an enlargement of part of the area partitioned by the plurality of source bus lines (SL1 to SLm+1) and the plurality of gate bus lines (GL1 to GLn), the illustrated part being partitioned by the 3 source bus lines (SL1 to SL3) and the 3 gate bus lines (GL1 to GL3).

In FIG. 10 the same reference characters are used to denote the elements common to the figures for Embodiment 1, and detailed explanations of these elements are omitted.

In Embodiment 1, the TFT 6 had a double gate structure and was formed to have a U-shape when seen in plan view. By contrast, the TFT 6D of the present embodiment has a single gate structure and has an L-shape when seen in plan view.

The TFT 6D includes a single gate electrode 13D. The gate electrode 13D extends in a direction parallel to the horizontal line direction. The TFT 6D has a single gate structure in which the gate electrode 13D is arranged along the gate bus line GL.

In FIG. 10, the reference characters LD1 and LD2 denote a first length and a second length, respectively.

In the present embodiment, the first length LD1 and the second length LD2 each remain unchanged before and after the occurrence of misalignment in the horizontal line direction.

According to the liquid crystal display device 1D of the present embodiment, even if misalignment occurs in the horizontal line direction of the TFTs 6D with the single gate structure, variation in the holding characteristics of the TFTs 6D is suppressed, making it possible to suppress deterioration in display quality.

### Embodiment 6

Embodiment 6 of the present invention will be explained below. The basic configuration of the liquid crystal display device of the present embodiment is similar to that of Embodiment 1, but differs in that IGZO, which is made up of oxides of indium, gallium and zinc (In—Ga—Zn—O semiconductor), is used as the formation material for the semiconductor layer. Hence, in the present embodiment, the formation materials of the semiconductor layer are explained while explanation of the basic configuration of the liquid crystal display device is omitted.

In Embodiment 1, an example was described in which a silicon semiconductor was used as the formation material of the semiconductor layer 12. By contrast, in the present embodiment, an example will be described in which an oxide semiconductor such as IGZO is used as the formation material of the semiconductor layer. Oxide semiconductors have a higher mobility than α-Si. Hence, TFTs that make use of an oxide semiconductor can operate at a higher speed than TFTs that use α-Si. Since the oxide semiconductor film can be formed by a simpler process than polycrystalline silicon film, the oxide semiconductor film can be employed in devices where a large surface area is required.

The oxide semiconductor layer can, for example, be formed as follows. First, an IGZO film with a thickness of 30 nm to 300 nm is formed on the insulating film using a sputtering method. Next, a resist mask that covers prescribed regions of the IGZO film is formed by photolithography. Next, portions of the IGZO film not covered by the resist mask are removed by wet etching. Thereafter, the resist mask is peeled away. In this way, the oxide semiconductor layer is obtained.

Note that for the oxide semiconductor, other oxide semiconductors besides IGZO can be used. For example, IZO formed from indium and zinc (In—Zn—O semiconductor) and ZTO formed from zinc and titanium (Zn—Ti—O semiconductor) can be used.

Preferred embodiments of the present invention have been described above with reference to drawings, but the present invention is not, of course, limited by the above described embodiments. The forms, combinations and the like of the components described in the above embodiments are merely examples, and various modifications based on design requirements or the like are possible without departing from the spirit of the present invention.

In addition, the specific descriptions relating to the shapes, quantities, arrangements, materials, forming methods and like of the constituent elements of the liquid crystal display device are not limited those in the above embodiments and can be modified as appropriate.

### INDUSTRIAL APPLICABILITY

The present invention can be used in a liquid crystal display device.

### DESCRIPTION OF REFERENCE CHARACTERS

1, 1A, 1B, 1C, 1D liquid crystal display device

3 source driver

4 gate driver

6, 6A, 6B, 6C, 6D TFT (thin-film transistor)

7, 7A, 7B, 7C, 7D pixel electrode

12 semiconductor layer

13a first gate electrode

13b second gate electrode

13Aa first gate electrode

13Ab second gate electrode

13Ac third gate electrode

13D gate electrode

120a first channel region (channel portion)

120b second channel region (channel portion)

121a first high-concentration impurity region (source portion)

121b second high-concentration impurity region (drain portion)

GL, GLD gate bus line

SL, SLD source bus line

L1 first length (length in vertical line direction of first low-concentration impurity region)

L2 second length (length in vertical line direction of second low-concentration impurity region)

L3 third length (length in vertical line direction of third low-concentration impurity region)

L4 fourth length (length in vertical line direction of fourth low-concentration impurity region)

L5 fifth length

L6 sixth length

1. A liquid crystal display device, comprising:
a plurality of source bus lines arranged to be adjacent to one another;
a plurality of gate bus lines arranged to be parallel to each other and to intersect with said plurality of source bus lines;
a plurality of thin film transistors respectively provided at intersections of said plurality of source bus lines and said plurality of gate bus lines;
a plurality of pixel electrodes provided in one-to-one correspondence with said plurality of thin film transistors, image signals being supplied to said plurality of pixel electrodes from said source bus lines via said thin film transistors; and
a source driver that respectively supplies said image signals to said plurality of source bus lines, said image signals reversing a polarity between positive potential and negative potential upon every period,
wherein, for each source bus line, the plurality of pixel electrodes respectively connected thereto is arranged along an extension direction of said source bus line and alternately disposed on one side and then another side in an arrangement direction of said source bus line,
wherein each of said plurality of thin film transistors includes a semiconductor layer having a source portion, a channel portion, and a drain portion, and a gate electrode formed by a portion of said gate bus line,
wherein said source portion, said channel portion, and said drain portion are arranged so as to be adjacent to one another in a direction perpendicular to the arrangement direction of said plurality of source bus lines, and
wherein said gate electrode extends in a direction parallel to the arrangement direction of said plurality of source bus lines, and is arranged to face said channel portion.

2. The liquid crystal display device according to claim 1,
wherein said semiconductor layer includes a channel region that functions as said channel portion, high-concentration impurity regions that respectively function as said source portion and said drain portion, and low-concentration impurity regions provided between said channel region and said high-concentration impurity regions, and
wherein, in each of said plurality of thin film transistors, a length of said low-concentration impurity region in the extension direction of said source bus lines remains unchanged upon a shift in relative position of said plurality of gate bus lines and said plurality of thin film transistors in the arrangement direction of the plurality of source bus lines.

3. The liquid crystal display device according to claim 1, wherein each of said plurality of thin film transistors has a multi-gate structure having a plurality of said gate electrodes each formed by a portion of the gate bus line, said plurality of gate electrodes being arranged along said gate bus line.

4. The liquid crystal display device according to claim 3, wherein each of said plurality of thin film transistors has a double gate structure with said gate electrodes being respectively arranged in two locations along said gate bus line.

5. The liquid crystal display device according to claim 3, wherein each of said plurality of thin film transistors has a triple gate structure with said gate electrodes being respectively arranged in three locations along said gate bus line.

6. The liquid crystal display device according to claim 1, wherein each of said plurality of thin film transistors has a single gate structure having said gate electrode that is formed by a portion of the gate bus line being arranged along said gate bus line.

7. The liquid crystal display device according to claim 1, wherein holding characteristics of each of said plurality of thin film transistors remain unchanged upon a shift in relative positions of said plurality of gate bus lines and said plurality of thin film transistors in the arrangement direction of the plurality of source bus lines.

8. The liquid crystal display device according to claim 1, wherein, when a region partitioned by adjacent said source bus lines and adjacent said gate bus lines is designated as a single pixel, an arrangement of a plurality of said pixels is a stripe arrangement.

9. The liquid crystal display device according to claim 1, wherein, when a region partitioned by adjacent said source bus lines and adjacent said gate bus lines is designated as a single pixel, an arrangement of a plurality of said pixels is a delta arrangement.

10. The liquid crystal display device according to claim 1, wherein said semiconductor layer is formed of indium, gallium, zinc, and oxygen.

11. The liquid crystal display device according to claim 2, wherein each of said plurality of thin film transistors has a multi-gate structure having a plurality of said gate electrodes each formed by a portion of the gate bus line, said plurality of gate electrodes being arranged along said gate bus line.

12. The liquid crystal display device according to claim 2, wherein each of said plurality of thin film transistors has a single gate structure having said gate electrode that is formed by a portion of the gate bus line being arranged along said gate bus line.

13. The liquid crystal display device according to claim 2, wherein holding characteristics of each of said plurality of thin film transistors remain unchanged upon a shift in relative positions of said plurality of gate bus lines and said plurality of thin film transistors in the arrangement direction of the plurality of source bus lines.

14. The liquid crystal display device according to claim 3, wherein holding characteristics of each of said plurality of thin film transistors remain unchanged upon a shift in relative positions of said plurality of gate bus lines and said plurality of thin film transistors in the arrangement direction of the plurality of source bus lines.

15. The liquid crystal display device according to claim 4, wherein holding characteristics of each of said plurality of thin film transistors remain unchanged upon a shift in relative positions of said plurality of gate bus lines and said plurality of thin film transistors in the arrangement direction of the plurality of source bus lines.

16. The liquid crystal display device according to claim 5, wherein holding characteristics of each of said plurality of thin film transistors remain unchanged upon a shift in relative positions of said plurality of gate bus lines and said plurality of thin film transistors in the arrangement direction of the plurality of source bus lines.

17. The liquid crystal display device according to claim 6, wherein holding characteristics of each of said plurality of thin film transistors remain unchanged upon a shift in relative positions of said plurality of gate bus lines and said plurality of thin film transistors in the arrangement direction of the plurality of source bus lines.

18. The liquid crystal display device according to claim 11, wherein holding characteristics of each of said plurality of thin film transistors remain unchanged upon a shift in relative positions of said plurality of gate bus lines and said plurality of thin film transistors in the arrangement direction of the plurality of source bus lines.

19. The liquid crystal display device according to claim 12, wherein holding characteristics of each of said plurality of thin film transistors remain unchanged upon a shift in relative positions of said plurality of gate bus lines and said plurality of thin film transistors in the arrangement direction of the plurality of source bus lines.
